(19) United States
(12) Patent Application Publication
(10) Pub. No.: US 2020/0037390 A1
(43) Pub. Date: Jan. 30, 2020

(54) Handling of Drop Events of Traffic Flows

(71) Applicant: Telefonaktiebolaget LM Ericsson (publ), Stockholm (SE)

(72) Inventors: Rasmus Axén, Linköping (SE); Sofia Svedevall, Brokind (SE)

(21) Appl. No.: 16/337,594

(22) PCT Filed: Sep. 29, 2016
(86) PCT No.: PCT/EP2016/073201

§ 371 Date: Mar. 28, 2019

(51) Int. Cl. H04W 76/36; H04L 12/26; H04W 24/08; H04W 28/02

(52) U.S. Cl. CPC H04W 76/36; H04L 43/0852; H04W 28/0268; H04W 28/0247; H04W 28/0289; H04W 24/08

(57) ABSTRACT

There is provided mechanisms for handling drop events of traffic flows. A method is performed by a monitor entity. The method comprises monitoring a traffic flow between an access node and a wireless device. The method comprises generating a drop event only when the traffic flow fails to fulfil a delay requirement.

### TECHNICAL FIELD

Embodiments presented herein relate to a method, a monitor entity, a computer program, and a computer program product for handling drop events of traffic flows. Embodiments presented herein further relate to a method, an analyser entity, a computer program, and a computer program product for handling drop events of traffic flows.

### BACKGROUND

In communications networks, there may be a challenge to obtain good performance and capacity for a given communications protocol, its parameters and the physical environment in which the communications network is deployed.

For example, one parameter in providing good performance and capacity for a given communications protocol in a communications network is efficient handling of radio link failures leading to possible dropped connections, hereinafter referred to as drop events.

Current mechanisms for detecting drop events are based on counters. In more detail, currently used counters are based on that the wireless device has a primary connection established. If that connection is dropped it will be counted as an abnormal release, and hence generate a drop event in the counter. Further, if is there is any data in the buffers (uplink or downlink), the abnormal release will be counted as a data drop, and hence generate a drop event in the counter. However, in a multi-connection scenario current mechanisms for detecting drop events do not necessarily reflect the user experience in a correct manner and it could be cumbersome to implement current mechanisms for detecting drop events in a multi-connection scenario.

Hence, there is still a need for an improved handling of drop events.

### SUMMARY

An object of embodiments herein is to provide efficient handling of drop events of traffic flows.

According to a first aspect there is presented a method for handling drop events of traffic flows. The method is performed by a monitor entity. The method comprises monitoring a traffic flow between an access node and a wireless device. The method comprises generating a drop event only when the traffic flow fails to fulfil a delay requirement.

According to a second aspect there is presented a monitor entity for handling drop events of traffic flows. The monitor entity comprises processing circuitry. The processing circuitry is configured to cause the monitor entity to monitor a traffic flow between an access node and a wireless device. The processing circuitry is configured to cause the monitor entity to generate a drop event only when the traffic flow fails to fulfil a delay requirement.

According to a third aspect there is presented a monitor entity for handling drop events of traffic flows. The monitor entity comprises a monitor module configured to monitor a traffic flow between an access node and a wireless device. The monitor entity comprises a generate module configured to generate a drop event only when the traffic flow fails to fulfil a delay requirement.

According to a fourth aspect there is presented network node comprising a monitor entity according to the second aspect or the third aspect.

According to a fifth aspect there is presented wireless device comprising a monitor entity according to the second aspect or the third aspect.

According to a sixth aspect there is presented a computer program for handling drop events of traffic flows, the computer program comprising computer program code which, when run on processing circuitry of a monitor entity, causes the monitor entity to perform a method according to the first aspect.

According to a seventh aspect there is presented a method for handling drop events of traffic flows. The method is performed by an analyser entity. The method comprises obtaining a report of a drop event from a monitor entity, wherein the drop event pertains to a traffic flow between an access node and a wireless device having failed to fulfil a delay requirement. The method comprises initiating a root cause report of the drop event in response thereto.

According to an eighth aspect there is presented an analyser entity for handling drop events of traffic flows. The analyser entity comprises processing circuitry. The processing circuitry is configured to cause the analyser entity to obtain a report of a drop event from a monitor entity, wherein the drop event pertains to a traffic flow between an access node and a wireless device having failed to fulfil a delay requirement. The processing circuitry is configured to cause the analyser entity to initiate a root cause report of the drop event in response thereto.

According to a ninth aspect there is presented an analyser entity for handling drop events of traffic flows. The analyser entity comprises an obtain module configured to obtain a report of a drop event from a monitor entity, wherein the drop event pertains to a traffic flow between an access node and a wireless device having failed to fulfil a delay requirement. The analyser entity comprises an initiate module configured to initiate a root cause report of the drop event in response thereto.

According to a tenth aspect there is presented a network node comprising an analyser entity according to the eight aspect or the ninth aspect.

According to an eleventh aspect there is presented a computer program for handling drop events of traffic flows, the computer program comprising computer program code which, when run on processing circuitry of an analyser entity, causes the analyser entity to perform a method according to the seventh aspect.

According to a twelfth aspect there is presented a computer program product comprising a computer program according to at least one of the sixth aspect and the eleventh aspect and a computer readable storage medium on which the computer program is stored. The computer readable storage medium could be a non-transitory computer readable storage medium.

According to a thirteenth aspect there is presented a system comprising at least one monitor entity according to the second aspect or the third aspect and optionally at least one analyser entity according to the eighth aspect or the ninth aspect.

Advantageously these methods, these monitor entities, these analyser entities, these computer programs, and this system provide efficient handling of drop events, especially in multi-connection scenarios.

Advantageously these methods, these monitor entities, these analyser entities, these computer programs, and this system enable simple implementation in an access network configured for multi-connection scenarios.

Advantageously these methods, these monitor entities, these analyser entities, these computer programs, and this system enable network operators to tailor the handling of drop events separately for different services offered towards served wireless devices.

Advantageously these methods, these monitor entities, these analyser entities, these computer programs, and this system enable efficient comparisons between different access networks and features and their impact on the end-user experience.

Advantageously these methods, these monitor entities, these analyser entities, these computer programs, and this system provide an understanding of how the access network complies to the guaranteed bandwidth (not guaranteed bit rate (GBR), but a minimum service the wireless devices should expect) and delay.

Advantageously these methods, these monitor entities, these analyser entities, these computer programs, and this system are better fitted for packet based systems than current drop observability mechanisms.

It is to be noted that any feature of the first, second, third, fourth, fifth, sixth seventh, eight, ninth, tenth, eleventh, twelfth and thirteenth aspects may be applied to any other aspect, wherever appropriate. Likewise, any advantage of the first aspect may equally apply to the second, third, fourth, fifth, sixth, seventh, eight, ninth, tenth, eleventh, twelfth, and/or thirteenth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communications network according to embodiments;

FIGS. 2, 3, 4, and 5 are flowcharts of methods according to embodiments;

FIG. 6 is a schematic diagram illustrating a communications network according to embodiments;

FIGS. 7 and 8 are signalling diagrams according to embodiments;

FIG. 9 is a schematic diagram showing functional units of a monitor entity according to an embodiment;

FIG. 10 is a schematic diagram showing functional modules of a monitor entity according to an embodiment;

FIG. 11 is a schematic diagram showing functional units of an analyser entity according to an embodiment;

FIG. 12 is a schematic diagram showing functional modules of an analyser entity according to an embodiment; and

FIG. 13 shows one example of a computer program product comprising computer readable means according to an embodiment.

### DETAILED DESCRIPTION

The inventive concept will now be described more fully hereinafter with reference to the accompanying drawings, in which certain embodiments are shown. These embodiments are provided by way of example so that this disclosure will be thorough and complete. Like numbers refer to like elements throughout the description. Any step or feature illustrated by dashed lines should be regarded as optional.

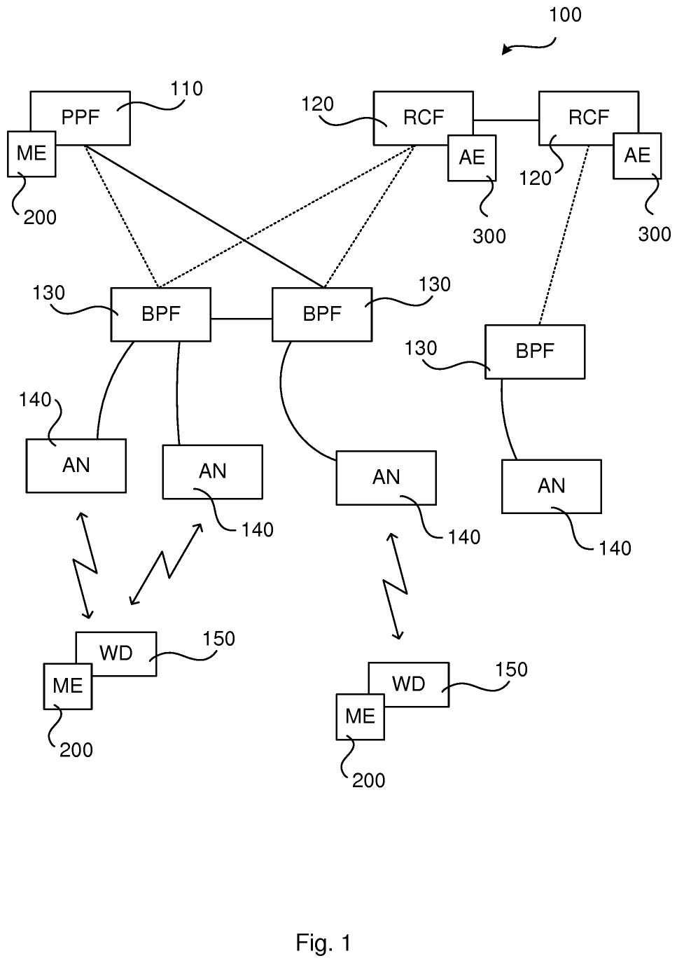

FIG. 1 is a schematic diagram illustrating a communications network 100 where embodiments presented herein can be applied. The communications network 100 comprises a Packet Processing Function (PPF) entity 110, two Radio Control Function (RCF) entities 120, three Baseband Processing Function (BPF) entities 130, and four Access Nodes (ANs) 140, all interconnected via interfaces as indicated by solid and dotted lines. The access nodes 140 provide wireless network access to served wireless devices (WD) 150; In the illustrative example of FIG. 1, one of the wireless devices 150 has a single connection to one access node 140 whereas one of the wireless devices 150 has a multi-connection to two access nodes 140.

The Packet Processing Function 110, and optionally at least some of the wireless devices 150, comprises a monitor entity (ME) 200 and the Radio Control Function 120 comprises an analyser entity (AE) 300. In general terms, the monitor entity 200 and the analyser entity 300 are configured for handling drop events of traffic flows to and from the wireless devices 150. Further details of the monitor entity 200 and the analyser entity 300 will be provided below.

In general terms, carrier aggregation enables a wireless device to use one or several secondary carriers which, together with the single primary carrier (the one carrying the control signaling), establish a multi-connection. The carrier aggregation is performed at the Media Access Control protocol layer. Another example of multi-connection is dual connectivity. For dual connectivity, aggregation is performed at Packet Data Convergence Protocol level. When using multi-connections, a connection could possibly survive even if the primary carrier drops, as long as there is an operational secondary carrier available and running; in fact the term primary carrier and secondary carrier may be skipped if all of the connections are equal. The connections might even be served by different parts of the access network, unaware of each other's existence. This will make it cumbersome to use current mechanisms for handling drop events, and it may be challenging for current mechanisms for handling drop events to correctly determine whether the wireless devices experience any degradation of running services or not.

In general terms Radio Resource Control (RRC) Connection Re-establishment is a mechanism according to which a wireless device can re-establish network connection quickly after it has experienced Radio Link Failure (RLF). Mechanisms have also been introduced that speed up connection setup going from idle state (denoted RRC_IDLE) to connected state (denoted RRC_CONNECTED). However, when a wireless device experiences RLF and the access network classifies this as an abnormal release it is not sure that the user experience is affected by the release since if the wireless device can re-establish network connection fast enough the release will not matter and should not be counted as a drop event. This does not necessarily imply that the RLF should not be monitored, although not from a user experience drop perspective. Whether the release should be considered as a drop event or not depends on the type of service run by the wireless device; the release should be considered as a drop event only when the interrupt time between drop and reconnect is not fast enough.

The embodiments disclosed herein therefore relate to mechanisms for handling drop events of traffic flows. In order to obtain such mechanisms there is provided a monitor entity 200, a method performed by the monitor entity 200, a computer program product comprising code, for example in the form of a computer program, that when run on processing circuitry of the monitor entity 200, causes the monitor entity 200 to perform the method. In order to obtain such mechanisms there is further provided an analyser entity 300, a method performed by the analyser entity 300, and a computer program product comprising code, for example in the form of a computer program, that when run on processing circuitry of the analyser entity 300, causes the analyser entity 300 to perform the method.

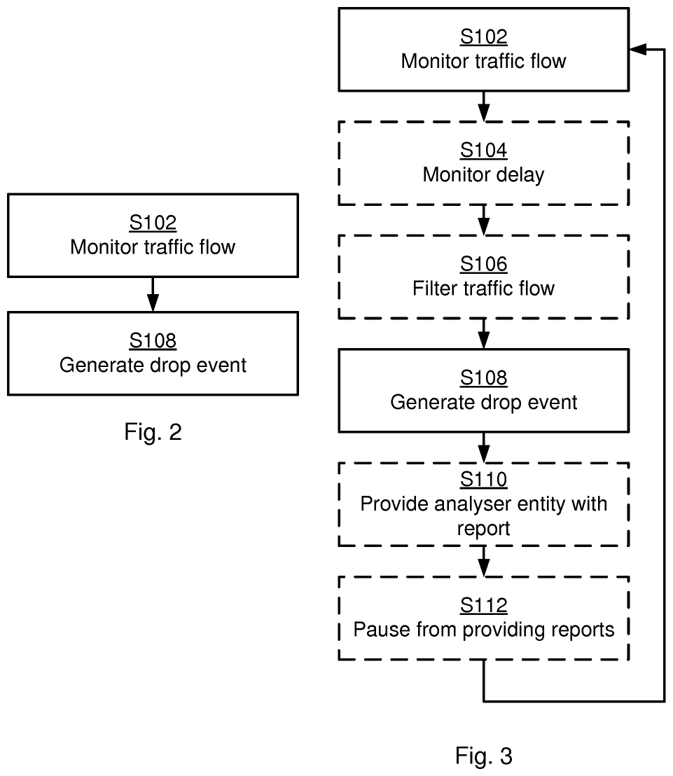

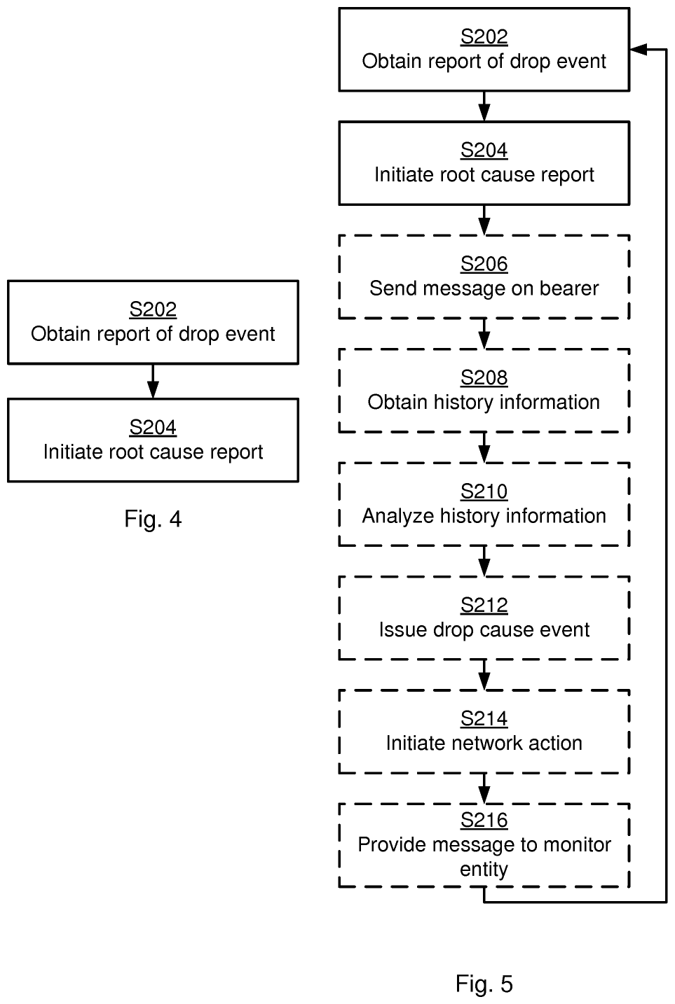

FIGS. 2 and 3 are flow charts illustrating embodiments of methods for handling drop events of traffic flows as performed by the monitor entity 200. FIGS. 4 and 5 are flow charts illustrating embodiments of methods for handling drop events of traffic flows as performed by the analyser entity 300. The methods are advantageously provided as computer programs 1320a, 1320b.

Reference is now made to FIG. 2 illustrating a method for handling drop events of traffic flows as performed by the monitor entity 200 according to an embodiment.

The monitor entity 200 is configured to monitor a traffic flow for possible drop events. Hence, the monitor entity 200 is configured to perform step S102:

S102: The monitor entity 200 monitors a traffic flow between an access node and a wireless device. The monitored traffic flow could use a multi-connection between the access node and the wireless device.

In general term, the monitor entity 200 monitors the delay for Internet Protocol (IP) packets for each wireless device and service. In particular, the monitor entity 200 is configured such that issues relating to known mechanisms for handling drop events are avoided, or at least reduced. Hence not all possible candidate events that could define a drop event are considered during the monitoring. Particularly, the monitor entity 200 is configured to perform step S108:

S108: The monitor entity 200 generates a drop event only when the traffic flow fails to fulfil a delay requirement.

This implicitly also captures throughput needs since if a higher throughput is required than the network can support the buffers will start to build up and eventually trigger the delay based drop indication.

By means of the herein disclosed mechanisms for generating drop events an indication can be provided that tells if the wireless device experiences any service degradation.

The herein disclosed mechanisms for generating drop events are agnostic to multi-connections and re-establishment features. That is, if multi-connections are added the monitoring in step S102 and the generating in step S108 are unaffected and will still indicate if and when a drop event occurs.

In a multi-connection scenario, more than one radio access technology (RAT) could be involved and hence the herein disclosed embodiments are applicable for handling drop events of traffic flows in multi-RAT networks.

Embodiments relating to further details of handling drop events of traffic flows as performed by the monitor entity 200 will now be disclosed.

Reference is now made to FIG. 3 illustrating methods for handling drop events of traffic flows as performed by the monitor entity 200 according to further embodiments. It is assumed that steps S102, S108 are performed as described above with reference to FIG. 2 and a thus repeated description thereof is therefore omitted.

There may be different types of information associated with the drop event. According to an embodiment the drop event comprises an identity of the wireless device and an indication of which Quality of Service class was used for the traffic flow when the drop event was generated.

In general terms, at least some of the herein disclosed embodiments are based on using a delay based model according to which a drop event is generated only when it takes longer than threshold delay value (e.g. defined in milliseconds) to send/receive a packet to/from the wireless device by monitoring packet buffers. Hence, according to an embodiment the monitor entity 200 is configured to perform step S104 as part of monitoring the traffic flow in step S102:

S104: The monitor entity 200 monitors delay between transmission and acknowledgement of packets sent between the access node and the wireless device. The drop event is generated in step S108 by the delay being larger than a threshold delay value.

If the access node is fast enough to recover a lost connection the monitor entity 200 will thus not generate a drop event and key performance indicators will be improved when introducing faster mechanism to handle radio link failures or other failure that causes an interruption time of the services towards the wireless device.

For uplink transmission (UL; from wireless device to access network), the delay could be measured (in the wireless device) as the time from when the wireless device sends a Scheduling Request (SR) for UL data until the data is acknowledged from the access network to the wireless device. This time is then compared to the configured delay budget for the service. Hence, according to an embodiment the delay is measured as time from when a scheduling request is sent by the wireless device to time when data corresponding to the scheduling request is acknowledged by the access node.

For downlink transmission (DL; from access node to wireless device), the delay could be defined as the time from when the access node receives the packet until the acknowledgement that it is sent to (and received by) the wireless device is received by the access node. Hence, according to an embodiment the delay is measured as time from when packets are sent by the access node to time when reception of the packets is acknowledged by the wireless device.

The threshold delay value could be mapped to the QoS class or similar. Hence, according to an embodiment the threshold delay value is based on a Quality or Service (QoS) indicator of the wireless device. Further, according to an embodiment the QoS indicator is a QoS class indicator (QCI).

It could be up to the network operator to define the threshold delay value. The threshold delay value can be influenced by main characteristics of the applications running in the UE. Very delay sensitive applications can be separated from the others using a different QoS class. This is in contrast to implementing the drop capability together with the control signaling of the wireless device.

For both UL and DL, a filter could be used to avoid that a temporary connection problem triggers a drop event. Hence, according to an embodiment the monitor entity 200 is configured to perform step S106:

S106: The monitor entity 200 filters the traffic flow such that the monitor entity 200 refrains from generating the drop event for delays caused by an amount of packets being smaller than a threshold size. The threshold size could be defined based on the service used for the traffic flow and could correspond to one single IP packet.

According to some aspects, if a drop occurred, the monitor entity 200 causes the analyser entity 300 to initiate a root cause report. Hence, according to an embodiment the monitor entity 200 is configured to perform step S110:

S110: The monitor entity 200 provides the analyser entity 300 with a report of the drop event in order for the analyser entity 300 to initiate a root cause report of the drop event.

According to some aspects, if a drop occurred, no more drop events are issued by the monitor entity 200 within a time window or until the monitor entity 200 receives information from the analyser entity 300 that an action has been taken. Hence, according to an embodiment the monitor entity 200 is configured to perform step S112:

S112: The monitor entity 200 pauses from providing the analyser entity 300 with reports of drop events (for the wireless device for which the drop event occurred) after having provided the analyser entity 300 with the report of the drop event either during a time window or until reception of a message from the analyser entity 300 to resume the provision of reports of drop events (by again entering step S102).

In this respect, the monitor entity 200 pausing from providing the analyser entity 300 with reports of drop events optionally includes the monitor entity 200 to pause from monitoring the traffic flow. The reception of the message in step S112 from the analyser entity 300 could thus be used by the monitor entity 200 to start monitoring drops for the wireless device and service again and/or for providing the analyser entity 300 with reports of drop events.

There might be a need to in parallel monitor dropped connections caused by radio link failures using current mechanisms for detecting drop events. Such dropped connections will indicate bad coverage, bad interference or bad handover relations. Theses radio link failures are not necessarily issued at the same time as the drop events generated by the monitor entity 200 in step S108.

Reference is now made to FIG. 4 illustrating a method for handling drop events of traffic flows as performed by the analyser entity 300 according to an embodiment.

As disclosed above, the monitor entity 200 in step S110 provides the analyser entity 300 with a report of the drop event. Hence, the analyser entity 300 is configured to perform step S202:

S202: The analyser entity 300 obtains a report of a drop event from the monitor entity 200. The drop event pertains to a traffic flow between an access node and a wireless device having failed to fulfil a delay requirement.

Upon having received the report the analyser entity 300 seeks to determine the root cause of the drop event. Hence, the analyser entity 300 is configured to perform step S204:

S204: The analyser entity 300 initiates a root cause report of the drop event in response thereto (i.e., in response to having received the report in step S202).

If a drop event has been generated, the analyser entity 300 can thus initiate a root cause report, for example by sending a special message using the used connections for the affected bearer (i.e., the bearer for which the drop event was generated). This will trigger involved layers to report back to their control instance (i.e. this allows a split between user plane and control plane if needed) of their status and the control instance can make an analysis and classify why the drop event occurred. If the traffic flow uses multi-connections (see above) the analyser entity 300 could need to receive all the reports for all connections to make the analysis.

The analyser entity 300 could access configurable rules for what can be causes for drop events. Examples are unsuccessful handover execution, radio quality being worse than a quality threshold, a buffer level being larger than buffer threshold, and used resources being degraded.

Embodiments relating to further details of handling drop events of traffic flows as performed by the analyser entity 300 will now be disclosed.

Reference is now made to FIG. 5 illustrating methods for handling drop events of traffic flows as performed by the analyser entity 300 according to further embodiments. It is assumed that steps S202, S204 are performed as described above with reference to FIG. 4 and a thus repeated description thereof is therefore omitted.

According to some aspects, the cause of the drop event is based on history data of the wireless device. When the drop event has been generated, the current configuration for the wireless device and service/bearer could be read in the wireless device handler. Information of what has happened for the different legs of the same service for the wireless device is therefore requested. Hence, according to an embodiment the analyser entity 300 is configured to perform step S206:

S206: The analyser entity 300 sends a message to all resource handlers currently used by the connections handling the bearer. The message requests information of resource usage of the bearer within a time window from when the drop event was generated.

The history information could comprise sent and/or received RRC messages, radio measurements, buffer statuses in the BPF, currently used sector carriers and/or link beams.

The analyser entity 300 analyses any history information obtained as a result of the message in step S206 being sent. Hence, according to an embodiment the analyser entity 300 is configured to perform steps S208 and S210:

S208: The analyser entity 300 obtains the history information.

S210: The analyser entity 300 analyses the history information in order to identify a cause of the drop event by comparing the history information to reference information.

According to some aspects, when the most probable cause of the drop event is found, a drop cause event is issued for the involved/originating cell or carrier, specific for the drop event and cause (e.g. pmUlDropHandover or pmDlDropBadQuality). Hence, according to an embodiment the cause is associated with a network entity and the analyser entity 300 is configured to perform step S212:

S212: The analyser entity 300 issues a drop cause event in the network entity.

The drop cause event could be associated with details such as target cell for handover or last measured DL quality. The drop cause event could further comprise an identifier of the second most probable cause of the drop event being generated.

According to some aspects, the drop event triggers the analyser entity 300 to initiate an action. Hence, according to an embodiment the bearer is associated with a set of connections and the analyser entity 300 is configured to perform step S214:

S214: The analyser entity 300 initiates a network action such that at least one of the connections in the set of connections is replaced with another connection to handle the traffic flow.

One example of such a network is a handover of the wireless device. In general terms, each bearer could consist of several connections towards the wireless device, i.e. one bearer can be sent using several frequency carriers (as in carrier aggregation).

According to some aspects, when the drop event is fully handled, and possible actions performed, the analyser entity 300 answers back to the monitor entity 200 that an action is taken. Hence, according to an embodiment the analyser entity 300 is configured to perform step S216:

S216: The analyser entity 300 provides the monitor entity 200 with a message for the monitor entity 200 to resume the monitoring when the analyser entity 300 has identified the cause of the drop event.

The analyser entity 300 could then enter step S202 again.

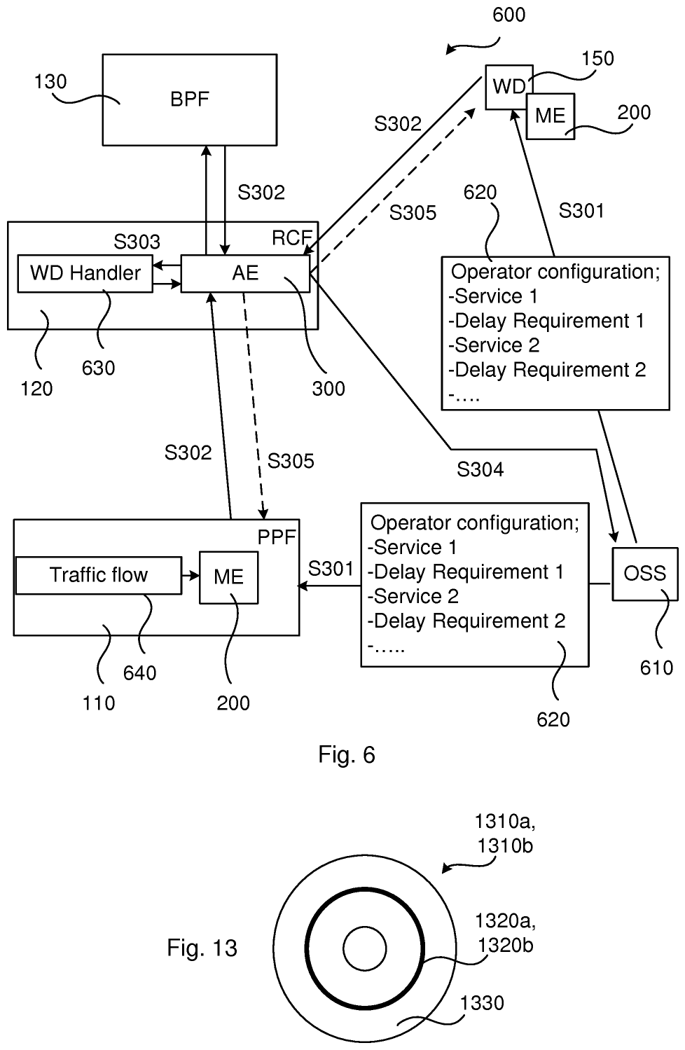

One particular embodiment for handling drop events of traffic flows based on at least some of the above disclosed embodiments will now be disclosed in detail with reference to the communications network 600 of FIG. 6.

The communications network 600 of FIG. 6 shows part of the communications network 100 of FIG. 1 and additionally illustrates an Operator Support System (OSS) providing operator configurations 620 to the PPF entity 110 and the wireless device 150. The PPF entity 110 handles a traffic flow 640. The operator configurations 620 specify delay requirements acting as threshold delay values for different services. A wireless device handler 630 is the control entity for the wireless device 150 and is provided in the RCF entity 120. The wireless device handler 630 is configured to keep information of currently handled wireless devices, such as capabilities, ongoing bearers, states and ongoing procedures; it controls mobility, issues measurements to be performed by the wireless device 150, etc. The wireless device handler 630 could also configure the wireless device 150 with dedicated configurations, such as with the operator configurations 620.

S301: The monitor entity 200 (provided in at least one of the PPF and the wireless device) is configured to capture events of traffic flows performing worse than required. A delay requirement is given for each service (or QoS class).

S302: If a traffic flow does not fulfill its requirements, e.g. one IP packet needed more time than the given delay requirement to be sent to or received from the wireless device, a drop event is generated in the monitor entity 200, including identities of the wireless device and the used service. This drop event is sent to the analyser entity 300. The traffic flow continues but no more drop events are issued and sent within a certain time window, or until information is sent back from analyser entity 300 that actions is taken.

S303: The analyser entity 300 collects history of the wireless device, i.e. information on what has recently happened to the affected wireless device, by looking up what resources are currently used by the wireless device and service in the wireless device handler, and requesting information from these resources. This wireless device history could consist of recently sent/received RRC messages, recent radio measurements and identities of used cells/areas and access nodes, etc. In more detail, wireless device history could identify current and recent resources, such as baseband processing unit or radio node unit, involved for the affected service. Also, the wireless device history could include used modulation and coding scheme, retransmissions used, etc.

S304: The analyser entity 300 analyses the wireless device history to find problems and ranks the problems found according to pre-defined rules. The problems could e.g. be a failed RRC procedure or radio quality or signal strength below certain threshold. The highest ranked problem is then assumed to have caused the drop event, and a drop cause event is issued for the cell/area involved. The drop cause event comprises also the most probable cause (highest ranked problem) and possibly lower ranked problems and corresponding cells/areas. The analyser entity 300 further initiates an action, if applicable, e.g. initiating a handover for a connection (one of several legs) where one or several drop events has occurred.

S305: The monitor entity 200 is informed when the analyser entity 300 has completed its analysis so that drop monitoring can be restarted.

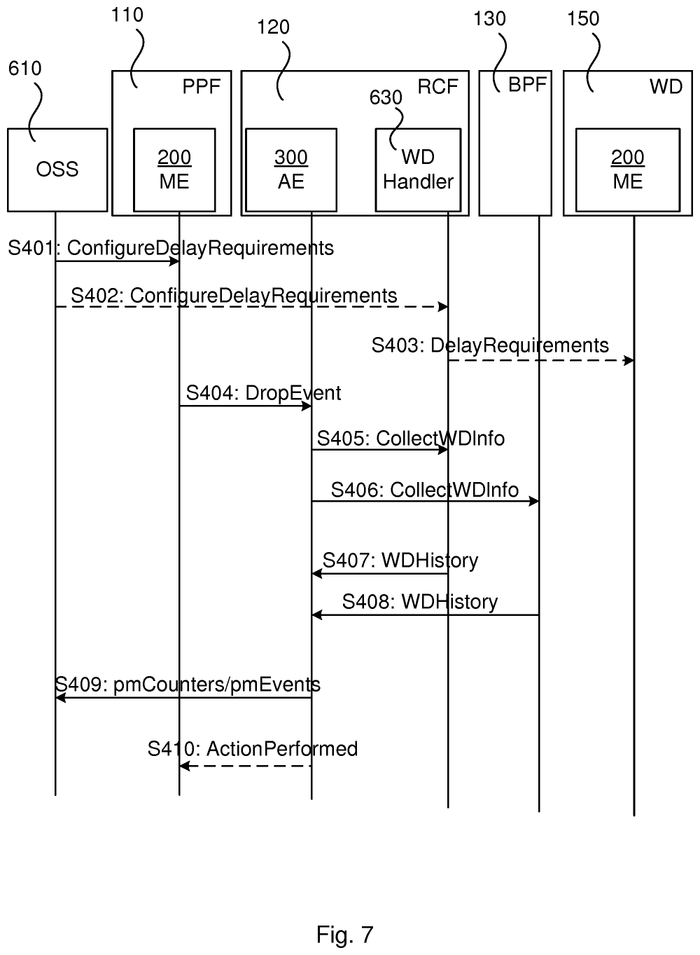

FIG. 7 is signalling diagram according to an embodiment when a drop event occurs for a DL transmission.

S401: The OSS 610 configures delay requirements by sending a ConfigureDelayRequirements message to the monitor entity 200 in the PPF entity 110.

S402: The OSS 610 configures delay requirements by sending a ConfigureDelayRequirements message to the wireless device handler 630 in the RCF entity 110. From an OSS point of view the PPF and RCF could be a single managed element, and in such a scenario only one single configuration message could be required.

S403: The wireless device handler 630 forwards the delay requirements by sending a configuration message with DelayRequirements as a parameter to the monitor entity 200 in the wireless device 150.

Steps S402 and S403 are optional.

S404: The monitor entity 200 in the PPF entity 110 generates a drop event and sends a report thereof to the analyser entity 300 in the RCF entity 120.

S405: The analyser entity 300 requests wireless device history information by sending a collectWDInfo message to the wireless device handler 630 in the RCF entity 110.

S406: The analyser entity 300 requests wireless device history information by sending a collectWDInfo message to the BPF entity 130.

S407: The wireless device handler 630 responds by sending wireless device history information in a WDHistory message to the analyser entity 300.

S408: The BPF entity corresponds by sending wireless device history information in a WDHistory message to the analyser entity 300.

S409: The analyser entity 300 issues a drop cause event by sending a pmCounter/pmEvents message to the OSS 610.

S410: The analyser entity 300 optionally notifies the monitor entity 200 in the PPF entity 110 by sending an ActionPerformed message.

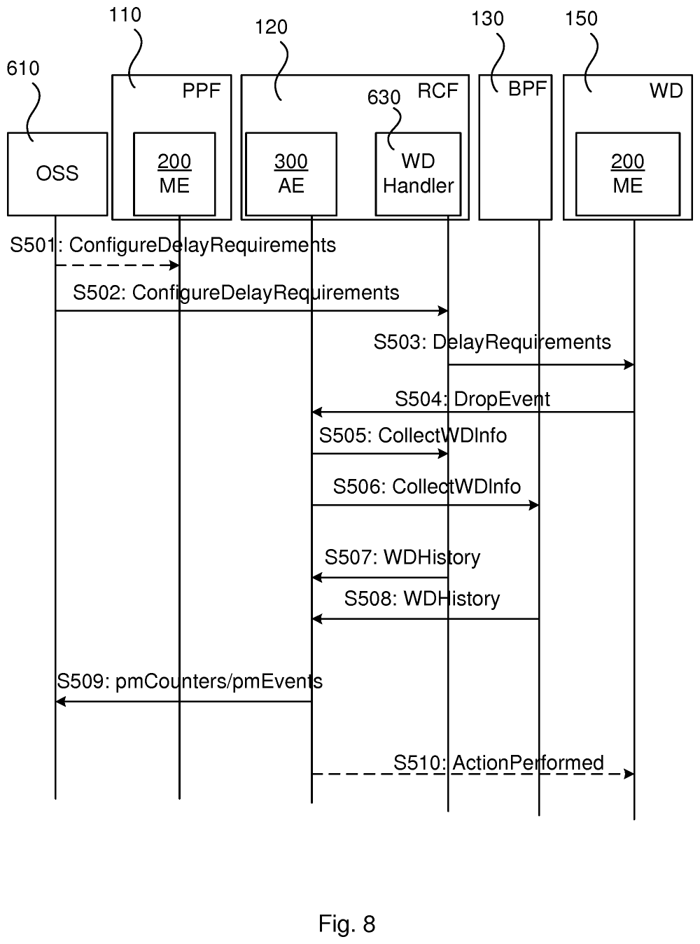

FIG. 8 is signalling diagram according to an embodiment when a drop event occurs for an UL reception.

S501: The OSS 610 configures delay requirements by sending a ConfigureDelayRequirements message to the monitor entity 200 in the PPF entity 110.

Step S501 is optional.

S502: The OSS 610 configures delay requirements by sending a ConfigureDelayRequirements message to the wireless device handler 630 in the RCF entity 110. From an OSS point of view the PPF and RCF could be a single managed element, and in such a scenario only one single configuration message could be required.

S503: The wireless device handler 630 forwards the delay requirements by sending a configuration message with DelayRequirements as a parameter to the monitor entity 200 in the wireless device 150.

An alternative to steps S502 and S503 is if a non access stratum (NAS) message includes the delay information to be used. This message could be sent transparently from the OSS or core network over the RCF to the wireless device 150.

S504: The monitor entity 200 in the wireless device 150 generates a drop event and sends a report thereof to the analyser entity 300 in the RCF entity 120

S505: The analyser entity 300 requests wireless device history information by sending a collectWDInfo message to the wireless device handler 630 in the RCF entity 110.

S506: The analyser entity 300 requests wireless device history information by sending a collectWDInfo message to the BPF entity 130.

S507: The wireless device handler 630 responds by sending wireless device history information in a WDHistory message to the analyser entity 300.

S508: The BPF entity corresponds by sending wireless device history information in a WDHistory message to the analyser entity 300.

S509: The analyser entity 300 issues a drop cause event by sending a pmCounter/pmEvents message to the OSS 610.

S510: The analyser entity 300 optionally notifies the monitor entity 200 in the wireless device 150 by sending an ActionPerformed message.

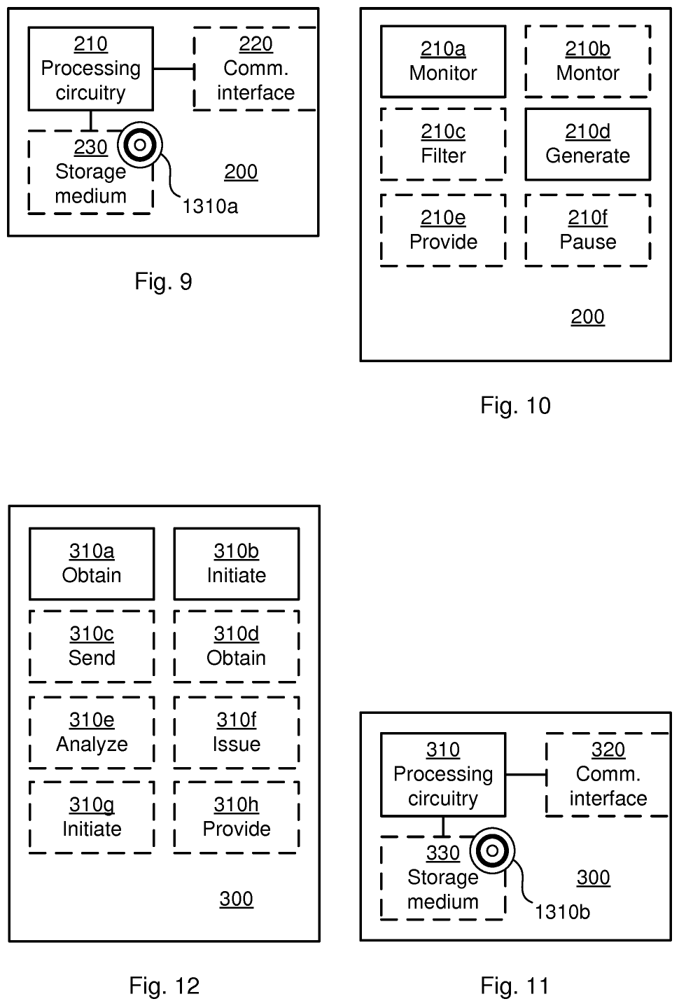

FIG. 9 schematically illustrates, in terms of a number of functional units, the components of a monitor entity 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1310a (as in FIG. 13), e.g. in the form of a storage medium 230. The processing circuitry 210 may further be provided as at least one application specific integrated circuit (ASIC), or field programmable gate array (FPGA).

Particularly, the processing circuitry 210 is configured to cause the monitor entity 200 to perform a set of operations, or steps, S102-S112, as disclosed above. For example, the storage medium 230 may store the set of operations, and the processing circuitry 210 may be configured to retrieve the set of operations from the storage medium 230 to cause the monitor entity 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The monitor entity 200 may further comprise a communications interface 220 for communications at least with the analyser entity 300. As such the communications interface 220 may comprise one or more transmitters and receivers, comprising analogue and digital components.

The processing circuitry 210 controls the general operation of the monitor entity 200 e.g. by sending data and control signals to the communications interface 220 and the storage medium 230, by receiving data and reports from the communications interface 220, and by retrieving data and instructions from the storage medium 230. Other components, as well as the related functionality, of the monitor entity 200 are omitted in order not to obscure the concepts presented herein.

FIG. 10 schematically illustrates, in terms of a number of functional modules, the components of a monitor entity 200 according to an embodiment. The monitor entity 200 of FIG. 10 comprises a number of functional modules; a monitor module 210a configured to perform step S102 and a generate module 210d configured to perform step S108. The monitor entity 200 of FIG. 10 may further comprise a number of optional functional modules, such as any of a monitor module 210b configured to perform step S104, a filter module 210c configured to perform step S106, a provide module 210e configured to perform step S110, and a pause module 210f configured to perform step S112. In general terms, each functional module 210a-210f may be implemented in hardware or in software. Preferably, one or more or all functional modules 210a-210f may be implemented by the processing circuitry 210, possibly in cooperation with functional units 220 and/or 230. The processing circuitry 210 may thus be arranged to from the storage medium 230 fetch instructions as provided by a functional module 210a-210f and to execute these instructions, thereby performing any steps of the monitor entity 200 as disclosed herein.

FIG. 11 schematically illustrates, in terms of a number of functional units, the components of an analyser entity 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1310b (as in FIG. 13), e.g. in the form of a storage medium 330. The processing circuitry 310 may further be provided as at least one application specific integrated circuit (ASIC), or field programmable gate array (FPGA).

Particularly, the processing circuitry 310 is configured to cause the analyser entity 300 to perform a set of operations, or steps, S202-S216, as disclosed above. For example, the storage medium 330 may store the set of operations, and the processing circuitry 310 may be configured to retrieve the set of operations from the storage medium 330 to cause the analyser entity 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The analyser entity 300 may further comprise a communications interface 320 for communications at least with the monitor entity 200. As such the communications interface 320 may comprise one or more transmitters and receivers, comprising analogue and digital components.

The processing circuitry 310 controls the general operation of the analyser entity 300 e.g. by sending data and control signals to the communications interface 320 and the storage medium 330, by receiving data and reports from the communications interface 320, and by retrieving data and instructions from the storage medium 330. Other components, as well as the related functionality, of the analyser entity 300 are omitted in order not to obscure the concepts presented herein.

FIG. 12 schematically illustrates, in terms of a number of functional modules, the components of an analyser entity 300 according to an embodiment. The analyser entity 300 of FIG. 12 comprises a number of functional modules; an obtain module 310a configured to perform step S202 and an initiate module 310b configured to perform step S204. The analyser entity 300 of FIG. 12 may further comprise a number of optional functional modules, such as any of a send module 310c configured to perform step S206, an obtain module 310d configured to perform step S208, an analyse module 310e configured to perform step S210, an issue module 310f configured to perform step S212, an initiate module 310g configured to perform step S214, and a provide module 310h configured to perform step S216. In general terms, each functional module 310a-310h may be implemented in hardware or in software. Preferably, one or more or all functional modules 310a-310h may be implemented by the processing circuitry 310, possibly in cooperation with functional units 320 and/or 330. The processing circuitry 310 may thus be arranged to from the storage medium 330 fetch instructions as provided by a functional module 310a-310h and to execute these instructions, thereby performing any steps of the analyser entity 300 as disclosed herein.

The monitor entity 200 and/or the analyser entity 300 may be provided as respective standalone devices or as a part of at least one further device. For example, the monitor entity 200 may be provided in an access node such as in the PPF entity 200 and/or in the wireless device 150. Alternatively, functionality of the monitor entity 200 may be distributed between at least two devices, or nodes. These at least two nodes, or devices, may either be part of the same network part (such as in the PPF entity 110) or may be spread between at least two such network parts. A monitor entity 200 provided in the PPF entity 110 could be configured for generating drop events for DL. A monitor entity 200 provided in the wireless device 150 could be configured for generating drop events for UL. For example, the analyser entity 300 may be provided in an access node such as in the RCF entity 120. Alternatively, functionality of the analyser entity 300 may be distributed between at least two devices, or nodes. These at least two nodes, or devices, may either be part of the same network part (such as in the RCF entity 120) or may be spread between at least two such network parts.

Thus, a first portion of the instructions performed by the monitor entity 200 and/or analyser entity 300 may be executed in a first device, and a second portion of the of the instructions performed by the monitor entity 200 and/or analyser entity 300 may be executed in a second device; the herein disclosed embodiments are not limited to any particular number of devices on which the instructions performed by the monitor entity 200 and/or analyser entity 300 may be executed. Hence, the methods according to the herein disclosed embodiments are suitable to be performed by a monitor entity 200 and/or analyser entity 300 residing in a cloud computational environment. Therefore, although a single processing circuitry 210, 310 is illustrated in FIGS. 9 and 11 the processing circuitry 210, 310 may be distributed among a plurality of devices, or nodes. The same applies to the functional modules 210a-210f, 310a-310h, of FIGS. 10 and 12 and the computer programs 1320a, 1320b of FIG. 13 (see below).

FIG. 13 shows one example of a computer program product 1310a, 1310b comprising computer readable means 1330. On this computer readable means 1330, a computer program 1320a can be stored, which computer program 1320a can cause the processing circuitry 210 and thereto operatively coupled entities and devices, such as the communications interface 220 and the storage medium 230, to execute methods according to embodiments described herein. The computer program 1320a and/or computer program product 1310a may thus provide means for performing any steps of the monitor entity 200 as herein disclosed. On this computer readable means 1330, a computer program 1320b can be stored, which computer program 1320b can cause the processing circuitry 310 and thereto operatively coupled entities and devices, such as the communications interface 320 and the storage medium 330, to execute methods according to embodiments described herein. The computer program 1320b and/or computer program product 1310b may thus provide means for performing any steps of the analyser entity 300 as herein disclosed.

In the example of FIG. 13, the computer program product 1310a, 1310b is illustrated as an optical disc, such as a CD (compact disc) or a DVD (digital versatile disc) or a Blu-Ray disc. The computer program product 1310a, 1310b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1320a, 1320b is here schematically shown as a track on the depicted optical disk, the computer program 1320a, 1320b can be stored in any way which is suitable for the computer program product 1310a, 1310b.

The inventive concept has mainly been described above with reference to a few embodiments. However, as is readily appreciated by a person skilled in the art, other embodiments than the ones disclosed above are equally possible, as defined by the appended patent claims.

1-30. (canceled)

31. A method for handling drop events of traffic flows, the method being performed by a monitor entity, the method comprising:
monitoring a traffic flow between an access node and a wireless device; and
generating a drop event only when the traffic flow fails to fulfil a delay requirement.

32. The method according to claim 31, wherein the drop event comprises an identity of the wireless device and an indication of which Quality of Service class was used for the traffic flow when the drop event was generated.

33. The method according to claim 31, wherein monitoring the traffic flow comprises:
monitoring delay between transmission and acknowledgement of packets sent between the access node and the wireless device; and wherein the drop event is generated by the delay being larger than a threshold delay value, wherein the threshold delay value is based on a Quality of Service (QoS) indicator of the wireless device.

34. The method according to claim 33, wherein the delay is either:
uplink delay and measured as time from when a scheduling request is sent by the wireless device to time when data corresponding to the scheduling request is acknowledged by the access node; or
downlink delay and measured as time from when packets are sent by the access node to time when reception of the packets is acknowledged by the wireless device.

35. The method according to claim 31, further comprising:
filtering the traffic flow such that the monitor entity refrains from generating the drop event for delays caused by an amount of packets being smaller than a threshold size.

36. The method according to claim 31, further comprising:
providing an analyser entity with a report of the drop event in order for the analyser entity to initiate a root cause report of the drop event.

37. The method according to claim 36, further comprising:
pausing from providing the analyser entity with reports of any further drop event after having provided the analyser entity with the report of the drop event either during a time window or until reception of a message from the analyser entity to resume the provision of reports of drop events.

38. A method for handling drop events of traffic flows, the method being performed by an analyser entity, the method comprising:
obtaining a report of a drop event from a monitor entity, wherein the drop event pertains to a traffic flow between an access node and a wireless device having failed to fulfil a delay requirement; and
initiating a root cause report of the drop event in response thereto.

39. The method according to claim 38, wherein the drop event occurs on a bearer of the traffic flow, and further comprising:
sending a message to all resource handlers currently used by connections handling the bearer, the message requesting history information of resource usage of the bearer within a time window from when the drop event was generated.

40. The method according to claim 39, further comprising:
obtaining the history information; and
analysing the history information in order to identify a cause of the drop event by comparing the history information to reference information.

41. The method according to claim 40, wherein the cause is associated with a network entity, and wherein the method further comprises:
issuing a drop cause event in the network entity.

42. A monitor entity for handling drop events of traffic flows, the monitor entity comprising:
processing circuitry configured to cause the monitor entity to:
monitor a traffic flow between an access node and a wireless device; and
generate a drop event only when the traffic flow fails to fulfil a delay requirement.

43. The monitor entity according to claim 42, wherein the drop event comprises an identity of the wireless device and an indication of which Quality of Service class was used for the traffic flow when the drop event was generated.

44. The monitor entity according to claim 42, wherein the processing circuitry is configured to cause the monitor entity to monitor the traffic flow by monitoring delay between transmission and acknowledgement of packets sent between the access node and the wireless device, and wherein the drop event is generated by the delay being larger than a threshold delay value, wherein the threshold delay value is based on a Quality of Service (QoS) indicator of the wireless device.

45. The monitor entity according to claim 44, wherein the delay is either:
uplink delay and measured as time from when a scheduling request is sent by the wireless device to time when data corresponding to the scheduling request is acknowledged by the access node; or
downlink delay and measured as time from when packets are sent by the access node to time when reception of the packets is acknowledged by the wireless device.

46. The monitor entity according to claim 42, wherein the processing circuitry is further configured to cause the monitor entity to:
filter the traffic flow such that the monitor entity refrains from generating the drop event for delays caused by an amount of packets being smaller than a threshold size.

47. The monitor entity according to claim 42, wherein the processing circuitry is further configured to cause the monitor entity to:
provide an analyser entity with a report of the drop event in order for the analyser entity to initiate a root cause report of the drop event.

48. The monitor entity according to claim 47, wherein the processing circuitry is further configured to cause the monitor entity to:
pause from providing the analyser entity with reports of any further drop event after having provided the analyser entity with the report of the drop event either during a time window or until reception of a message from the analyser entity to resume the provision of reports of drop events.

49. A wireless device comprising:
a communications interface; and
a monitor entity for handling drop events of traffic flows, the monitor entity comprising
processing circuitry configured to cause the monitor entity to:
monitor a traffic flow between an access node and a wireless device; and
generate a drop event only when the traffic flow fails to fulfil a delay requirement.

50. An analyser entity for handling drop events of traffic flows, the analyser entity comprising:
processing circuitry configured to cause the analyser entity to:
obtain a report of a drop event from a monitor entity, wherein the drop event pertains to a traffic flow between an access node and a wireless device having failed to fulfil a delay requirement; and
initiate a root cause report of the drop event in response thereto.

51. The analyser entity according to claim 38, wherein the drop event occurs on a bearer of the traffic flow, and wherein the processing circuit is further configured to cause the analyser entity to send a message to all resource handlers currently used by connections handling the bearer, the message requesting history information of resource usage of the bearer within a time window from when the drop event was generated.

52. The analyser entity according to claim 51, wherein the processing circuit is further configured to cause the analyser entity to:
obtain the history information; and
analyse the history information in order to identify a cause of the drop event by comparing the history information to reference information.

53. The analyser entity according to claim 52, wherein the cause is associated with a network entity, and wherein the processing circuit is further configured to cause the analyser entity to issue a drop cause event in the network entity.

54. A network node comprising:
an analyser entity for handling drop events of traffic flows, the analyser entity comprising processing circuitry configured to cause the analyser entity to:
obtain a report of a drop event from a monitor entity, wherein the drop event pertains to a traffic flow between an access node and a wireless device having failed to fulfil a delay requirement; and
initiate a root cause report of the drop event in response thereto.
